(19) United States
(12) Patent Application Publication
(10) Pub. No.: US 2006/0203408 A1
(43) Pub. Date: Sep. 14, 2006

(54) METHOD AND SYSTEM OF LOCATING OPENED OVER CURRENT PROTECTION DEVICES

(75) Inventor: Sjon C. Moore, Livonia, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 10/906,877

(22) Filed: Mar. 10, 2005

(51) Int. Cl. H02H 3/08

(52) U.S. Cl. 361/93.1

(57) ABSTRACT

Method and system of locating over current protection devices (OCPDs). The method and system including associating an indicator with one or more OCPDs such that the indicator(s) identify one or more OCPDs if the OCPDs are blown, triggered, tripped, discharged, or otherwise opened.

### BACKGROUND OF THE INVENTION

1. Field of the Invention

The present invention relates to methods and system of locating opened over current protection devices (OCPDs).

2. Background Art

Junction boxes, power boxes, and other power distribution type electronic units may include over current protection devices (OCPDs), such as fuses, positive temperature coefficient (PTC) devices, and the like, to control over current situations. For example, in automotive applications, it is common to use OCPDs to protect wiring from overheating during short conditions. In operation, the OCPDs is tripped, triggered, opened, or otherwise authorized to prevent current flow to the subsystem associated with the short.

With one-use or disposable OCPDs, once the OCPD is opened, it remains opened and must be replaced or removed for correction in order to restore operation to the subsystem associated therewith, i.e., to return current flow thereto. The replacement of a triggered OCPD, such as in automotive applications, can be problematic as it is often inconvenient and time consuming to locate the opened OCPD. Commonly, one only knows that the subsystem has failed and is left with inconvenient techniques to locate the OCPD associated therewith.

To locate the associated OCPD, one must resort to a schematic or other related document to search for the subsystem associated with the opened OCPD, which can be difficult and tedious, and/or one must resort to trial error type methods, such as ‘plug and try’ or continuity tests. In more detail, a ‘plug and try’ test includes a one-by-one replacement of each OCPD until the opened OCPD is determined and the continuity test includes a similar one-by-one analysis wherein a meter or other devices is used to test each OCPD until the opened OCPD is determined.

### SUMMARY OF THE INVENTION

One non-limiting aspect of the present invention relates to providing a convenient method and system of locating opened over current protection devices (OCPDs). The method and system may be used in any number of environments where OCPDs are used to control current flow, including automotive and non-automotive applications.

One non-limiting aspect of the present invention relates to a junction box. The junction box may include a over current protection device (OCPD) and a light emitting diode (LED) connected in parallel with the OCPD such that current bypasses the LED if the OCPD is closed and passes through the LED to cause the LED to light if the OCPD is opened. Preferably, the LED is positioned proximate the OCPD so as to light upon opening of the OCPD to indicate the OCPD as being opened.

In accordance with one non-limiting aspect of the present invention, the junction box may further include a resistor combined in series with the LED such that the LED and resistor are connected in parallel with the OCPD so that the resistor establishes a trickle current through the LED if the OCPD is opened.

In accordance with one non-limiting aspect of the present invention, the junction box may further include a housing configured to be mounted within an automobile and configured to include a cover through which the OCPD may be withdrawn by a user for replacement. Preferably in this configuration, the LED is positioned proximate the OCPD and visible through the cover such that the user may easily discover if the OCPD is opened based on whether the LED is lit.

One aspect of the present invention relates to a vehicle unit having a number of over current protection devices (OCPDs) that open at predefined current conditions to control current flow to at least one associated vehicle subsystem. The OCPDs may be replaced or otherwise reset if opened to restore operation to the associated subsystem by a user pulling out the opened OCPD and plugging in a new OCPD.

In accordance with one non-limiting aspect of the present invention, the vehicle unit includes at least one indicator associated with one or more of the OCPDs to identify which one or more OCPDs are without requiring ‘plug and try’ operations or ‘continuity’ tests so that the user may easily identify the opened OCPD(s).

In accordance with one non-limiting aspect of the present invention, the vehicle unit includes at least one indicator for each OCPD. The indicator may include a light emitting diode (LED) in series with a resistor, which together are connected in parallel with one of the OCPDs. In this configuration, the resistor acts a current regulator to cause a trickle current to flow through the LED if the OCPD is opened, wherein the trickle current causes the LED to emit light and thereby identify the one or more opened OCPDs so that the user may easily identify the opened OCPD(s).

One non-limiting aspect of the present invention relates to a method of locating one or more opened over current protection devices (OCPDs) in a junction box having a number of OCPDs. The method may include associating an indicator with each OCPD and locating the one or more opened OCPDs as a function of whether the indicator associated therewith is active.

In accordance with one non-limiting aspect of the present invention, the method may further include configuring the indicator to become active if the OCPD is opened and to remain inactive if the OCPD is not opened.

In accordance with one non-limiting aspect of the present invention, the method may further include positioning the indicators proximate the associated OCPDs such that the indicators must be visible to locate the one or more opened OCPDs.

In accordance with one non-limiting aspect of the present invention, the method may further include configuring the OCPDs to be removable through a cover of the junction box and positioning the indicators to be visible through the cover such the one or more opened OCPDs are identified by the active indicator associated therewith, and thereby, facilitate replacement of the opened OCPD(s) without requiring ‘plug and try’ operations or ‘continuity’ tests.

In accordance with one non-limiting aspect of the present invention, the method may further include positioning the junction box within an automobile so that the indicators are visible from either a passenger compartment or engine compartment thereof.

In accordance with one non-limiting aspect of the present invention, the method may further include configuring the indicator to include a visual display connected in parallel with each OCPD such that current bypasses the visual displays if the associated OCPD is closed and passes to the visual display of each opened OCPD to identify the opened OCPD associated therewith if the associated OCPD is opened.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a junction box in accordance with one non-limiting aspect of the present invention; and

FIGS. 2 and 3 illustrate the operation of a circuit in accordance with one non-limiting aspect of the present invention.

### DETAILED DESCRIPTION OF THE PREFERRED EMBODIMENT(S)

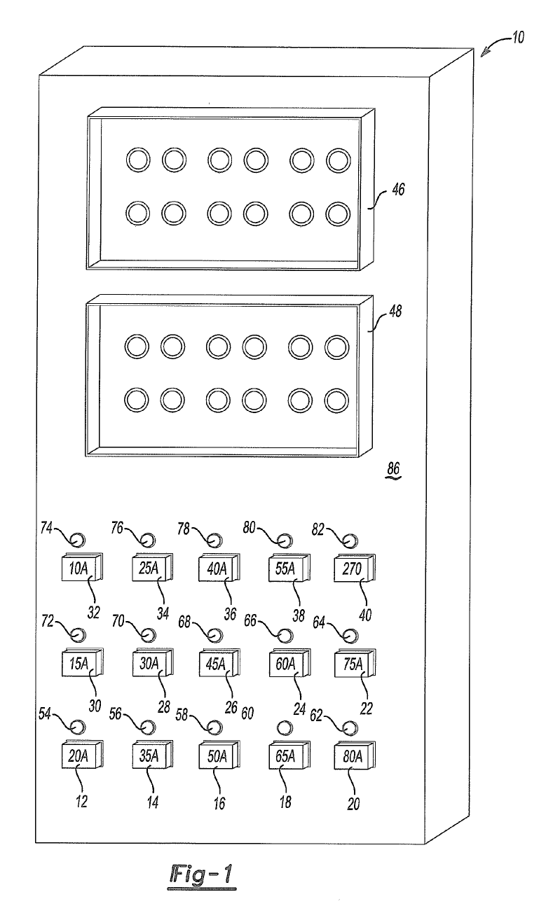

FIG. 1 illustrates a junction box 10 in accordance with one non-limiting aspect of the present invention. The junction box 10 relates to a unit commonly found in automobiles and other devices having electronic circuits. The junction box 10 may be configured to perform any number of electrical operations, including signal routing, power distribution, multiplexing, and other operations.

As one skilled in the art will appreciate, the configuration of the junction box 10 and the operations performed thereby are design specific and may change from application to application. In accordance with one non-limiting aspect of the present invention, the junction box 10 may include a number of over current protection devices (OCPDs) 12-40 to control current flow during short circuit or other over current conditions.

The OCPDs 12-40 may be tripped, triggered, blown, discharged, or otherwise opened to prevent or control current flow to a subsystem (not shown) associated therewith. With respect to automobiles, for example, the junction box 10 may include a number of wire harness connector terminals 46-48 for connecting wire harnesses thereto. The wire harnesses may provide power feeds, signals feeds, and the like to the junction box 10 whereby the junction box 10 then routes the signals through the OCPDs 12-10 for delivery to the associated subsystems.

The OCPDs 12-40 may comprise any number of configurations and features for controlling and/or preventing current flow to the associated subsystem. As such, the present invention is not intended to be limited to any particular arrangement or configuration of the OCPDs 12-40. However, the present invention at least contemplates the OCPDs 12-40 being one or more of a fuse, a positive temperature coefficient (PTC) device, or other device that must be replaced, removed for correction, or otherwise reset, either manually or through a self-setting operation, if opened during a short circuit or over current condition.

For example, in automobiles, the junction box 10 may include a number of OCPDs 12-40, such as fuses, to control current flow to any number of subsystems, such as a head-light subsystem, a navigation subsystem, an entertainment subsystem, and any other electronically operable vehicle subsystem. When one or more OCPDs 12-40 are opened, the opened OCPD 12-40 prevents current flow to the subsystem associated therewith such that that system is no longer operable until the OCPD 12-40 is replaced, fixed, reset or otherwise manipulated, either manually or through a self-setting operation, so that current may again flow to the associated subsystem.

One non-limiting aspect of the present invention relates to assisting a user in locating the opened OCPD 12-40 without having to perform inconvenient and time consuming operations, such as the above-described schematic search, ‘plug and try’ test, and continuity test. In particular, and in accordance with one non-limiting aspect of the present invention, one or more indicators 54-82 are associated with the OCPDs 12-40 to indicate which one or more OCPDs 12-40 are opened. In this manner, the user is able to easily discover and replace the opened OCPD(s) 12-40.

Of course, the present invention is not intended to be limited to locating OCPDs 12-40 in junction boxes or only vehicle electrical systems. Rather, the present invention contemplates locating OCPDs 12-40 in any number of automotive and non-automotive environments where OCPDs 12-40 are utilized, including power boxes, battery chargers, smart junction boxes, laptops, cell phones, and any other system, including printed circuit board based systems.

In accordance with one non-limiting aspect of the present invention, and as shown in FIG. 1, at least one indicator 54-82 is associated with each OCPD 12-40. In operation, the indicators 54-82 may be inactive until the associated OCPD 12-40 is opened so that one may easily identify the opened OCPD(s) 12-40 based on the indicator 54-82 associated therewith becoming active while the other indicators 54-82 remain inactive. The indicators 54-82 and OCPDs 12-40 may extend through a cover 86 of the junction box 10 to facilitate viewing the indicators 54-82 and removing and replacing the OCPDs 12-40.

In particular, the indicators 54-82 may include light emitting diodes (LEDs) and the OCPDs 12-40 may be typical two-pronged, plug-in-play type fuses which a user may grasp with their fingers or pliers for removal. The LEDs may be configured to remain inactive unit the OCPD 12-40 associated therewith is opened and to become activate (light) upon opening of the associated OCPD 12-40, thereby indicating the opened OCPD 12-40. Once the LED is lit, the user may restore operation to the subsystem associated therewith by removing the opened OCPD 12-40 and replacing it with a new one, ceasing operation associated with the effected subsystem, such as in the case of a PTC device, so that the OCPD may reset through a self-setting operation, or otherwise resetting its operation.

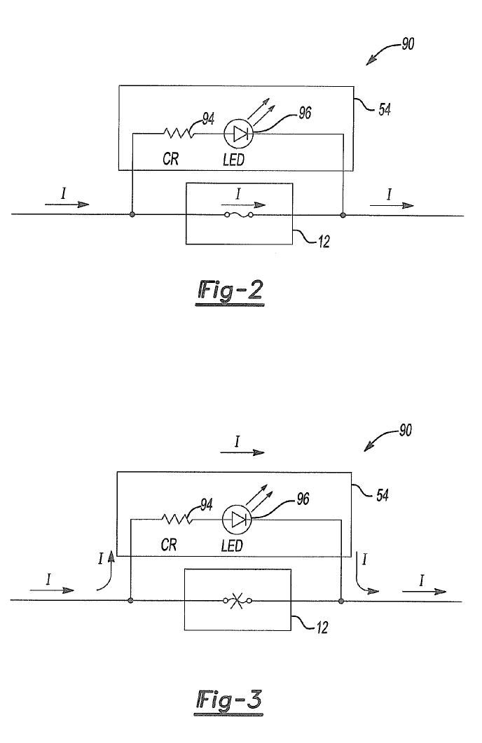

FIGS. 2 and 3 illustrates the operation of a OCPD circuit 90 in accordance with one non-limiting aspect of the present invention. In general, the OCPD circuit 90 includes an indicator 54 which is preferably inactive if the associated OCPD 12 is closed such that it becomes active if the associated OCPD 12 is triggered, tripped, blown, or otherwise opened.

In accordance with one non-limiting aspect of the present invention, the indicator 54 includes a current regulator 94 combined in series with a LED 96 such that combination thereof is connected in parallel with the OCPD 12, which for illustrative purposes is shown to be a fuse.

As shown in FIG. 2, when the OCPD 12 is closed, current flows through the OCPD 12 and bypasses the current regulator 94 and LED 96. Typically, the current flows through the OCPD 12 to one of the aforementioned current driven subsystem. As shown in FIG. 3, when the OCPD 12 is opened, current flows through the current regulator 94 to light the LED 96, thereby causing the LED 96 to indicate the OCPD 12 as being opened.

In this manner, the LED 96 is powered by the current which was previously flowing through the OCPD 12, and therefore, becomes active only upon the OCPD 12 opening. As such, only the indicators 54-82 associated with the opened OCPDs 12-40 receive current and current bypasses the indicators 54-82 associated with the closed OCPDs 12-40. Accordingly, if the indicator 54-82 is an LED, it will remain lit until the OCPD 12-40 is replaced, i.e, until current flow through the OCPD 12-40 is restored such that it bypasses the indicator 54-82.

The current regulator 94 may be any number of devices and features, such as a resistor, to control current flow through the LED 96 and onto the subsystem associated therewith. This current may be referred to as a trickle current as it trickles current to the affected subsystem. Typically, the trickle current is relatively insignificant in that it fails to permit operation of the subsystem and heating of the wire used to deliver the current to the subsystem.

In accordance with one non-limiting aspect of the present invention, the junction box 10 may be configured for use in an automobile, such as for under the dash applications where a user may view the box 10 from the passenger compartment and under the hood application where a user may view the box from the engine compartment. In each application, the indicators 54-82 and OCPDs 12-40 are preferably visible to facilitate identifying and replacing the opened OCPD(s) 12-40.

The present invention contemplates any number of configurations for the indicators 54-82, OCPDs 12-40, and OCPD circuit 90 and is not intended to be limited to the foregoing. In particular, the present invention contemplates the indicators comprising any number of other features besides LEDs, such as electrical feeds that relay signals to an instrument panel display in a cockpit of a vehicle so that the instrument panel display may be used to indicate the opened OCPD 12-40, such as with an alphanumeric identifier, and/or a feed to a system microprocessor.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A vehicle unit having a number of over current protection devices (OCPDs) that open at predefined current conditions to control current flow to at least one associated vehicle subsystem, the vehicle unit comprising:
at least one indicator associated with one or more of the OCPDs to identify which one or more OCPDs are opened without requiring ‘plug and try’ operations or ‘continuity’ tests so that the user may easily identify the opened OCPD(s), the indicators being separate from the OCPDs such that the same indicator may be repeatedly used if the associated OCPDs opens and wherein each indicator is configured to provide a trickle current to a load of the associated OCPD.

2. The vehicle unit of claim 1 wherein at least one indicator is associated with each OCPD, the indicator including a light emitting diode (LED) in series with a resistor, each indicator being connected in parallel with only one OCPD such that for each indicator the trickle current set by the resistor flows through the LED if the associated OCPD is opened, wherein the trickle current causes the LED to emit light and thereby identify the one or more opened OCPDs so that the user may easily identify the opened OCPD(s).

3. The vehicle unit of claim 1 wherein the indicator includes a visual display connected in parallel with each OCPD such that current bypasses the visual displays if the associated OCPD is closed and passes to the visual display of each opened OCPD to identify the opened OCPD associated therewith if the associated OCPD is opened.

4. The vehicle unit of claim 3 wherein the visual displays are light emitting diodes (LEDs).

5. The vehicle unit of claim 1 wherein the indicator is powered with current associated with the OCPD.

6. The vehicle unit of claim 5 wherein the current powers the indicator only if the OCPD is opened such that the indicator is inactive unless the OCPD is opened.

7. The vehicle unit of claim 1 wherein the indicator is powered with direct current (DC).

8. The vehicle unit of claim 1 further comprising:
a current regulator in cooperation with the indicator to control trickle current to the subsystems associated with the one or more opened OCPDs, wherein the trickle current is only provided if the OCPD is opened.

9. The vehicle unit of claim 1 wherein the indicator includes a instrument panel display within a cockpit that identifies the one or more opened OCPDs.

10. A junction box, the junction box comprising:
a over current protection device (OCPD);
a light emitting diode (LED) connected in parallel with the OCPD such that current bypasses the LED if the OCPD is closed and passes through the LED to cause the LED to light if the OCPD is opened;
wherein the LED is separate from the OCPD such that the OCPD is replaceable without replacing the LED and positioned proximate the OCPD so as to light upon opening of the OCPD to indicate the OCPD as being opened; and
wherein the LED is connected to the OCPD in such as manner as to facilitate transmission of a trickle current from the LED to a load of the OCPD.

11. The junction box of claim 10 further comprising
a resistor combined in series with the LED such that the LED and resistor are connected in parallel with the OCPD, wherein the resistor establishes the trickle current through the LED if the OCPD is opened.

12. The junction box of claim 10 further comprising:
a housing configured to be mounted within an automobile and including a cover through which the OCPD may be withdrawn by a user for replacement, wherein the LED is positioned proximate the OCPD and visible through the cover such that the user may easily discover if the OCPD is opened based one whether the LED is lit.

13. A method of locating one or more opened over current protection devices (OCPDs) in a junction box having a number of OCPDs, the method comprising:
associating an indicator with each OCPD, the indicators separately configured to become active if the associated OCPD is opened such that current is delivered through the indicator to an associated load and to remain inactive if the associated OCPD is not opened;
locating the one or more opened OCPDs as a function of whether the indicator associated therewith is active; and
replacing the OCPD associated with at least one of the active indicators without replacing the active indicator such that the same indicator is repeatedly used for different OCPDs, wherein the active indicator becomes inactive when the associated OCPD is replaced such that proper replacement is determined from the OCPD becoming inactive.

14. The method of claim 13 further comprising:
positioning the indicators proximate the associated OCPDs such that the indicators must be visible to locate the one or more opened OCPDs.

15. The method of claim 14 further comprising:
configuring the OCPDs to be removable through a cover of the junction box and positioning the indicators to be visible through the cover such [[the]] that one or more opened OCPDs are identified by the active indicator associated therewith and thereby facilitate replacement of the opened OCPD(s) without requiring ‘plug and try’ operations or ‘continuity’ tests.

16. The method of claim 13 further comprising:
positioning the junction box within an automobile so that the indicators are visible from either a passenger compartment or engine compartment thereof.

17. The method of claim 13 further comprising:
configuring each indicator to include a light emitting diode (LED) such that the LED becomes active and lights if the associated OCPD is opened and remains inactive and does not light if the associated OCPD is closed.

18. The method of claim 17 further comprising:
connecting each LED in parallel with the associated OCPD such that current bypasses the LED if the associated OCPD is closed and passes through the LED if the OCPD is opened.

19. The method of claim 18 further comprising:
controlling a trickle current as a function of a current regulator combined in series with each LED such that each LED and current regulator combination is connected in parallel with the associated OCPD.

20. The method of claim 13 further comprising:
configuring the indicator to include a visual display connected in parallel with each OCPD such that current bypasses the visual displays if the associated OCPD is closed and passes to the visual display of each opened OCPD to identify the opened OCPD associated therewith if the associated OCPD is opened.
